(19) United States
(12) Patent Application Publication
(10) Pub. No.: US 2013/0294677 A1
(43) Pub. Date: Nov. 7, 2013

(54) DEFECT INSPECTION METHOD AND DEFECT INSPECTION DEVICE

(71) Applicants: Takahiro Urano, Ebina (JP); Toshifumi Honda, Yokohama (JP); Shunji Maeda, Yokohama (JP)

(72) Inventors: Takahiro Urano, Ebina (JP); Toshifumi Honda, Yokohama (JP); Shunji Maeda, Yokohama (JP)

(21) Appl. No.: 13/989,840

(22) PCT Filed: Oct. 21, 2011
(86) PCT No.: PCT/JP2011/005900

§ 371 Date: Jul. 18, 2013

(30) Foreign Application Priority Data
Nov. 29, 2010 (JP) 2010-264488

(51) Int. Cl. G06T 7/00

(52) U.S. Cl. CPC G06T 7/001
USPC 382/141

(57) ABSTRACT

There is provided a defect inspection method including the steps of: acquiring image data sets of a sample under a plurality of imaging conditions; storing a plurality of image data sets acquired under the plurality of imaging conditions in an image storage unit; acquiring a defect candidate from each of the plurality of image data sets; cutting out, from the image data sets acquired under at least two imaging conditions and stored in the image storage unit, a partial images each including a position of the defect candidate detected in any of the plurality of image data sets and the periphery of the defect candidate position; and integrating the partial images acquired under at least two imaging conditions corresponding to the defect candidates, thereby classifying the defect candidates.

### TECHNICAL FIELD

The present invention relates to a defect inspection method for inspecting a minute defect existing on a surface of a sample with high sensitivity and a defect inspection device therefor.

### BACKGROUND ART

Thin-film devices such as a semiconductor wafer, a liquid crystal display, and a hard disk magnetic head are manufactured through a plurality of processing stages. In the manufacture of such thin-film devices, appearance inspection is performed for each of the series of several processes with the aim of improving and stabilizing a yield. In Patent Literature 1 (JP No. 3566589), there is disclosed “a method for detecting a defect such as a pattern defect or a foreign matter based on a reference image and an inspection image obtained by using lamp light, laser light, or electron beams in regions corresponding to two patterns formed so as to essentially have the same shape in an appearance inspection”. In Patent Literature 2 (JP-A-2006-98155), there is further disclosed “an inspection method for optimizing various inspection conditions, by effectively extracting a DOI and surely teaching it, in such a state that a small number of DOIs slip into a large number of Nuisances”. In Patent Literatures 3 (U.S. Pat. No. 7,221,992) and 4 (U.S. Pat. No. 2008/0285023), as a method for improving inspection sensitivity more, there is disclosed “a method for simultaneously detecting images under a plurality of different optical conditions, performing a comparison for each condition in brightness between the detected image and a reference image, and integrating comparison values to determine defects and noises”. Further, there are problems in that a high data transfer rate is needed for supplying a high-resolution defect image acquired under respective optical conditions to a defect determination unit, and in that a processor to exhibit high processing performance is needed in order to simultaneously process images under a plurality of conditions. In Patent Literature 5 (U.S. Pat. No. 7,283,659), there is disclosed “a method for efficiently performing a defect classification by using a two-tiered determination, namely, a classification of defect candidates through a non-image feature such as process information and that through a defect image feature”.

### CITATION LIST

### Patent Literature

Patent Literature 1: JP No. 3566589
Patent Literature 2: JP-A-2006-98155
Patent Literature 3: U.S. Pat. No. 7,221,992
Patent Literature 4: U.S. Pat. No. 2008/0285023
Patent Literature 5: U.S. Pat. No. 7,283,659

### SUMMARY OF INVENTION

### Technical Problem

Based on the above conventional techniques, when using a configuration in which images under different optical conditions are detected and integrated simultaneously, a high-rate data transfer unit and a memory or a storage medium of high capacity are needed to transfer and store images acquired under respective optical conditions. Further, the optical conditions for images to be integrated depend on a device configuration and are limited thereto. When images under the respective optical conditions for objects to be inspected are imaged in time series by scanning a stage, displacement due to a stage travel error occurs between images under different optical conditions. Therefore, positions between the images need to be corrected and integrated. However, when optical conditions are different, a pattern of a target object may look totally different. To calculate a positional correction amount, a detection image in a wide range is needed and there is a problem in that processing time and memory capacity are increased.

To limit detection images to be processed, in the conventional technique, defect candidates are narrowed based on non-image features such as process information.

### Solution to Problem

The following is a brief description of the gist of the representative elements of the invention disclosed in this application.

(1) There is provided a defect inspection method including the steps of: acquiring image data sets of a sample under a plurality of imaging conditions; storing the plurality of image data sets acquired under the plurality of imaging conditions in an image storage unit; acquiring a defect candidate from each of the plurality of image data sets; cutting out, from the image data sets acquired under at least two imaging conditions and stored in the image storage unit, partial images each including a position of the defect candidate detected in any of the plurality of image data sets and the periphery of the defect candidate position; and integrating the partial images acquired under at least two imaging conditions corresponding to the defect candidates, thereby classifying the defect candidates.

### Advantageous Effects of Invention

According to the present invention disclosed in this application, there are provided a defect inspection method for inspecting minute defects existing on a surface of a sample with high sensitivity and a defect inspection device therefor.

### BRIEF DESCRIPTION OF DRAWINGS

FIG. 1 illustrates one example of a configuration of a first embodiment of a defect inspection device according to the present invention;

FIG. 2 illustrates one example of a configuration of an image acquisition unit in the first embodiment of the defect inspection device according to the present invention;

FIG. 3 illustrates one example of a configuration of a defect candidate extraction unit in the first embodiment of the defect inspection device according to the present invention;

FIG. 4 illustrates one example of a configuration of a defect candidate detection unit in the first embodiment of the defect inspection device according to the present invention;

FIG. 5 illustrates one example of a configuration of a chip in the first embodiment of the defect inspection device according to the present invention;

FIG. 6 illustrates one example of a conversion function for compressing a bit rate in the first embodiment of the defect inspection device according to the present invention;

FIG. 7 illustrates one example of the number of teaching defects and classification performance of a defect candidate selection unit in the first embodiment of the defect inspection device according to the present invention;

FIG. 8 illustrates one example of a feature space of the defect candidate selection unit in the first embodiment of the defect inspection device according to the present invention;

FIG. 9 illustrates one example of a configuration of a post-processing unit in the first embodiment of the defect inspection device according to the present invention;

FIG. 10 illustrates one example of a flow for determining a defect in the first embodiment of the defect inspection device according to the present invention;

FIG. 11 illustrates one example of extended display of a GUI for teaching a defect candidate in the first embodiment of the defect inspection device according to the present invention;

FIG. 12 illustrates one example of a configuration of a second embodiment of the defect inspection device according to the present invention;

FIG. 13 illustrates one example of a configuration of an integration defect candidate extraction unit in the second embodiment of the defect inspection device according to the present invention;

FIG. 14 illustrates one example of a configuration of a third embodiment of the defect inspection device according to the present invention;

FIG. 15 illustrates one example of a configuration of an integration defect classification unit in the third embodiment of the defect inspection device according to the present invention;

FIG. 16 illustrates one example of displacement detection and correction in the third embodiment of the defect inspection device according to the present invention; and

FIG. 17 illustrates one example of a configuration of a SEM type inspection device in the first to third embodiments of the defect inspection device according to the present invention.

### DESCRIPTION OF EMBODIMENTS

Hereinafter, embodiments of the present invention will be described in detail with reference to the accompanying drawings. In all drawings for describing the embodiments, the same components are indicated by the same reference numerals in principle, and descriptions will not be repeated.

### First Embodiment

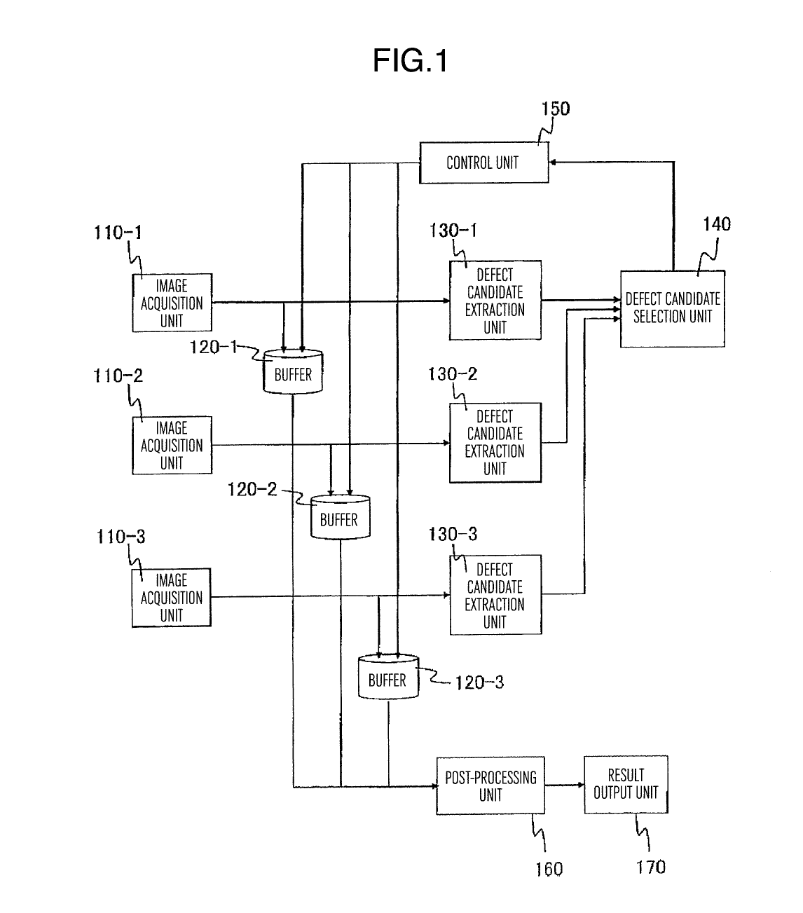

Hereinafter, a first embodiment of a defect inspection technique (a defect inspection method and a defect inspection device) of the present invention will be described in detail with reference to FIGS. 1 to 11.

In the first embodiment of a pattern inspection technique of the present invention, a defect inspection device and a defect inspection method under dark-field illumination with respect to a semiconductor wafer will be described as an example.

FIG. 1 illustrates one example of the configuration of the defect inspection device of the first embodiment. The defect inspection device according to the first embodiment includes image acquisition units 110 (110-1, 110-2, and 110-3), image storage buffers 120 (120-1, 120-2, and 120-2), defect candidate extraction units 130 (130-1, 130-2, and 130-3), a defect candidate selection unit 140, a control unit 150, an integration post-processing unit 160, and a result output unit 170. The image acquisition units 110 acquire inspection image data of a semiconductor wafer, and transfer the image data to the image storage buffers 120 and the defect candidate extraction units 130. The defect candidate extraction units 130 extract defect candidates from the image data transferred from the image acquisition units 110 through a process to be hereinafter described, and transfer the defect candidates to the defect candidate selection unit 140. The defect candidate selection unit 140 eliminates, from the defect candidates, disinformation being false detection such as noises or Nuisance that a user does not want to detect, and transmits the left defect candidate information to the control unit 150. From the control unit 150 to the image storage buffers 120, coordinates of the left defect candidates are transmitted. From the image data stored in the image storage buffers 120, an image including defect candidates is cut out and the defect candidate image is transferred to the integration post-processing unit 160. The integration post-processing unit 160 extracts from the defect candidate image only a DOI (Defect of Interest) being a defect that the user wants to detect through a process to be hereinafter described, and supplies the DOI to the result output unit 170.

In FIG. 1, the defect inspection device has the image storage buffers 120-1, 120-2, and 120-3, and the defect candidate extraction units 130-1, 130-2, and 130-3 with respect to the image acquisition units 110-1, 110-2, and 110-3 which acquire images under three different acquisition conditions of inspection images. Here, the acquisition conditions of the inspection image include illumination conditions and detection conditions for samples, and inspection image acquisitions at different detection sensitivities.

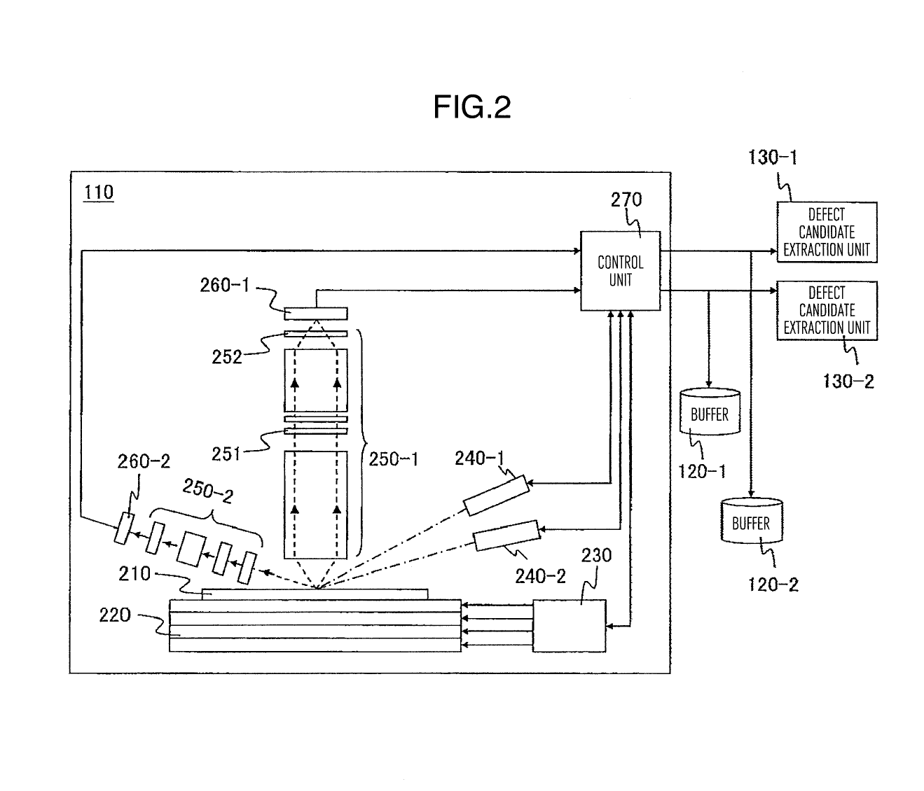

FIG. 2 illustrates one example of a configuration of the image acquisition unit 110 under a dark-field illumination in the first embodiment. The image acquisition unit 110 includes a stage 210, a mechanical controller 230, two illumination optical systems (illumination units) 240-1 and 240-2, detection optical systems (upper detection system) 250-1 and (oblique detection system) 250-2, and image sensors 260-1 and 260-2. The detection optical system further has a spatial frequency filter 251 and an analyzer 252.

Examples of the sample 210 include an object to be inspected such as a semiconductor wafer. The sample 210 is mounted on the stage 220, and a rotation (θ) and a movement in an X-Y plane and a movement in a Z direction are enabled. The mechanical controller 230 is a controller which drives the stage 220. Light from the illumination unit 240 is irradiated on the sample 210 and scattered light from the sample 210 is imaged through the upper detection system 250-1 and the oblique detection system 250-2. An optical image to be imaged is further received by the respective image sensors 260, thus converting the optical image to an image signal. At this time, the sample 210 is mounted on the X-Y-Z-θ driven stage 220 and light scattered by foreign matters is detected while the stage 220 is moved in the horizontal direction, and as a result a detection result is acquired as a two-dimensional image.

As an illumination light source for the illumination unit 240, a laser may be used or a lamp may be used. Further, as a wavelength of light for each illumination light source, light of a short wavelength may be used, or light of a wideband wavelength (white light) may be used. In the case of using light of a short wavelength, for the purpose of raising the resolution of an image to be detected (detecting a minute defect), light (Ultra Violet Light: UV light) having a wavelength in an ultraviolet range may be used. In the case of using a laser as a light source, when it is a laser of a short wavelength, a unit (not illustrated) for reducing coherence can be provided on each of the illumination units 240.

Further, a time delay integrating type image sensor (Time Delay Integration Image Sensor: TDI image sensor) having a configuration in which a plurality of one-dimensional image sensors are two-dimensionally arrayed is adopted as the image sensor 260, and each one-dimensional image sensor transfers the detected signals to the one-dimensional image sensor of a next stage and adds them in synchronization with a movement of the stage 220, which permits a two-dimensional image to be acquired with high sensitivity at a relatively high speed. When a parallel output type sensor with a plurality of output taps is used as this TDI image sensor, an output from the sensor can be processed in parallel and detection can be performed at a higher speed. Further, when a backside illuminated sensor is used as the image sensor 260, detection efficiency can be raised up as compared to a case where a frontside illuminated sensor is used.

A detection result to be produced from the image sensors 260-1 and 260-2 is transferred via the control unit 270 to the image storage buffers 120-1 and 120-2 and the defect candidate extraction units 130-1 and 130-2.

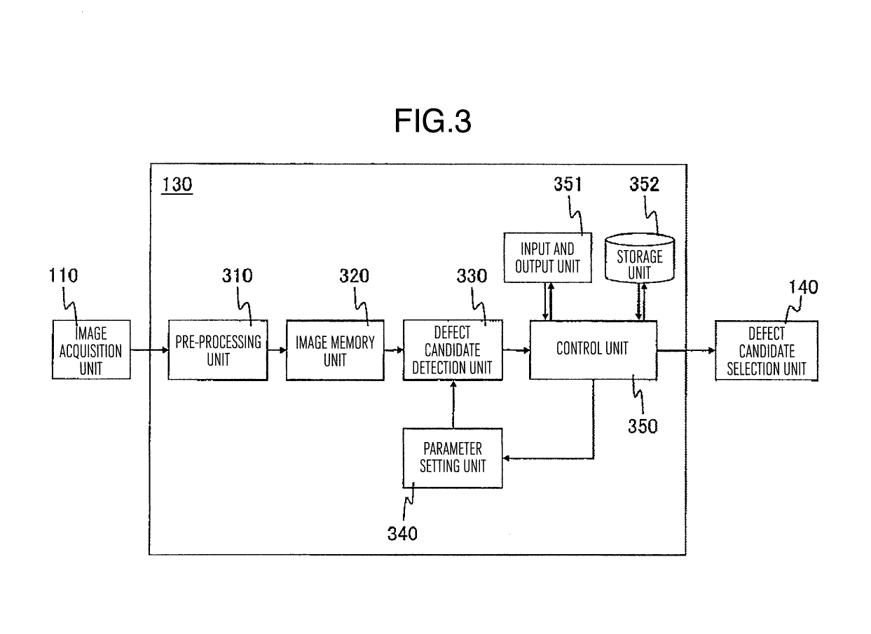

FIG. 3 illustrates one example of the configuration of the defect candidate extraction unit in the first embodiment. The defect candidate extraction unit 130 includes a pre-processing unit 310, an image memory unit 320, a defect candidate detection unit 330, a parameter setting unit 340, a control unit 350, a storage unit 360, and an input and output unit 370.

At first, the pre-processing unit 310 performs image correction such as shading correction, dark level correction, and bit compression to image data produced from the image acquisition unit 110, divides the image data to an image having a size of a fixed unit, and stores it in the image memory 320. There is read out digital signals of an image (hereinafter, described as a reference image) in a region corresponding to an image (hereinafter, described as a detection image) in a region to be inspected stored in the image memory 320. Here, as the reference image, an image of an adjacent chip may be used or an ideal image nondefective in an image and created from a plurality of adjacent chip images may be used. Further, the defect candidate detection unit 330 calculates a correction amount to align a plurality of adjacent chips and performs alignment between a detection image and a reference image by using a correction amount of the calculated position. Further, by using a feature amount of a corresponding pixel, the defect candidate detection unit 330 produces as a defect candidate a pixel being an outlier in a feature space. The parameter setting unit 340 sets an inspection parameter for a kind or threshold of a feature amount at the time of extracting a defect candidate supplied from the outside, and supplies it to the defect candidate detection unit 330. The defect candidate detection unit 330 supplies an image and a feature amount of the extracted defect candidate to the defect candidate selection unit 140 via the control unit 350. The control unit 350 includes a CPU which performs each type of control, and accepts a change in an inspection parameter (a kind and a threshold of a feature amount) from the user. The control unit 350 is further connected to an input and output unit 351 having an input unit and a display unit which displays detected defect information, and a storage unit 352 which stores a feature amount and an image of the detected defect candidate.

Here, all of the control units 150, 270, and 350 may be the same control unit, or configured by a different control unit, respectively, and connected to each other.

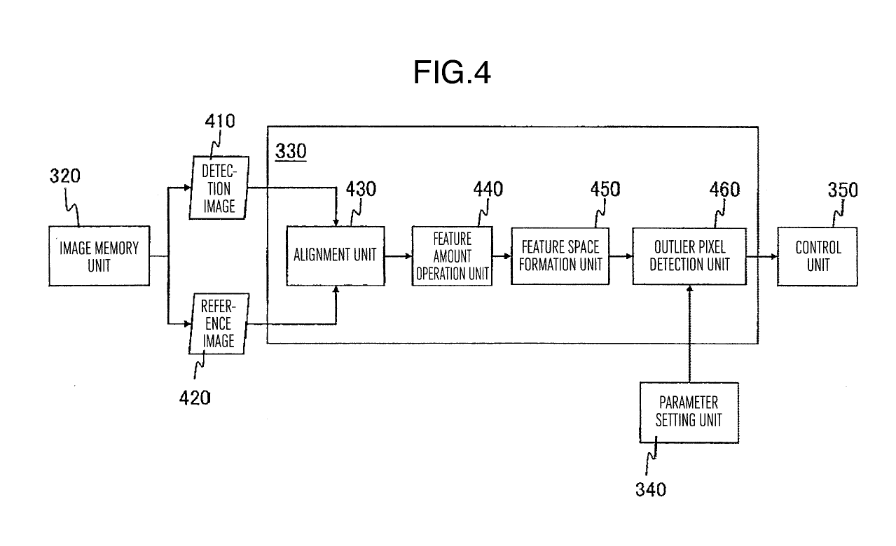

FIG. 4 illustrates one example of the configuration of the defect candidate detection unit 330 in the first embodiment. The defect candidate detection unit 330 includes an alignment unit 430, a feature amount operation unit 440, a feature space formation unit 450, and an outlier pixel detection unit 460. The alignment unit 430 detects displacement produced from the image memory unit 320 between a detection image 410 and a reference image 420 for correction. The feature amount operation unit 440 calculates a feature amount based on pixels corresponding to the reference image 420 and the detection image 440 in which a displacement is corrected by the alignment unit 430. The feature amount here calculated is defined as a brightness difference between the detection image 440 and the reference image 420, and a summation or a variation of the brightness difference in a given region. The feature space formation unit 450 forms a feature space based on an arbitrarily selected feature amount, and the outlier pixel detection unit 460 produces a pixel in a position deviated in the feature space as a defect candidate. The feature space formation unit 450 may perform normalization based on the displacement of each defect candidate. Here, as a reference for determining a defect candidate, variation in data points in the feature space and a distance from a center of gravity in the data points may be used. At this time, and a determination reference may be determined be using a parameter produced from the parameter setting unit 340.

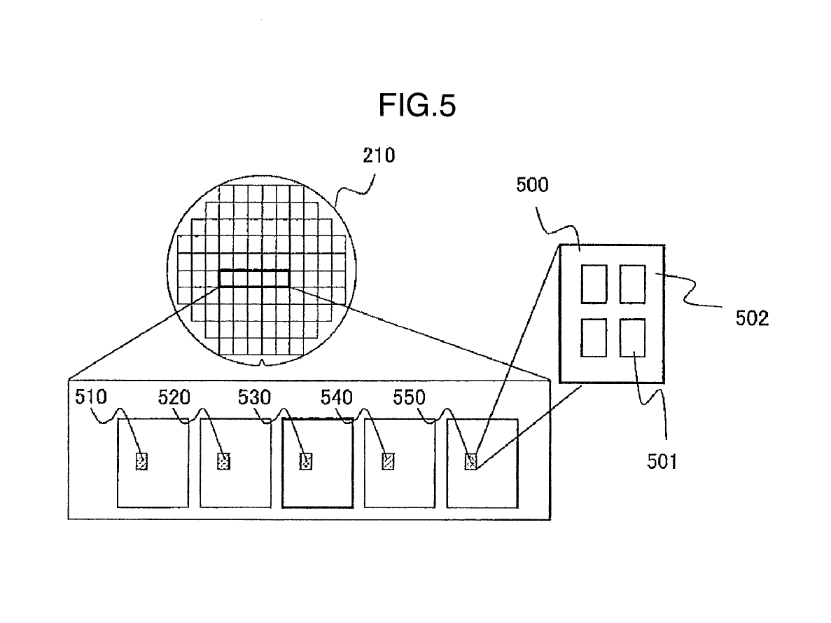

FIG. 5 illustrates one example of the configuration of a chip in the first embodiment of the defect inspection device according to the present invention, and detection of defect candidates in the defect candidate detection unit 330 will be described. On the sample (described as a semiconductor wafer, and also as a wafer) 210 to be inspected, a number of chips 500 having the same pattern and including a memory mat unit 501 and a peripheral circuit unit 502 are regularly arrayed. The control unit 270 continuously moves the semiconductor wafer 210 being a sample by using the stage 220 and sequentially takes in an image of a chip from the image sensors 2601 and 260-2 in synchronization with the above. With respect to a detection image, for example, a detection image in a region 530 of FIG. 5, the control unit 270 sets digital image signals in regions 510, 520, 540, and 550 in the same position in the regularly arrayed chips as reference images. Further, the control unit 270 compares pixels in the detection image with corresponding pixels in the reference image or other pixels in the detection image, and detects pixels with a large difference as a defect candidate.

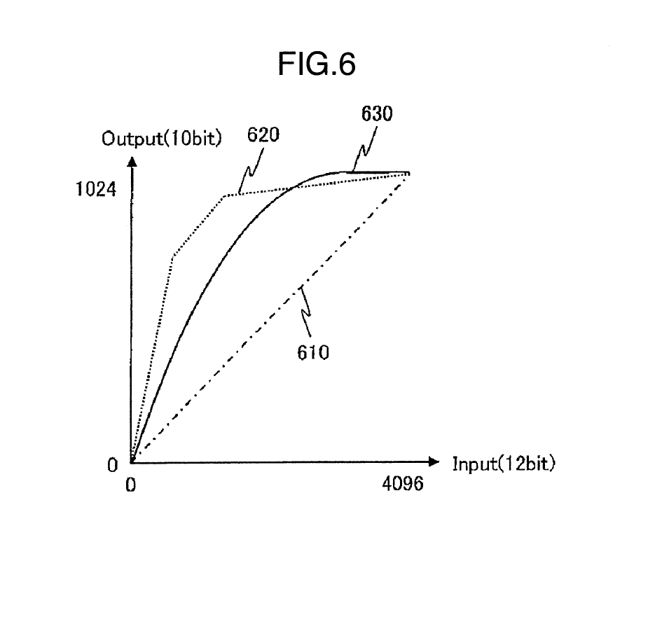

FIG. 6 illustrates one example of a function for compression in the case of performing data compression with respect to the image data produced from the image acquisition unit 110 in the pre-processing unit 310. FIG. 6 illustrates an example where image data input in 12 bits is compressed to 10 bits. In an example of a function 610, when a relationship between an input Iin and an output Iout is set to Iout=0.25×Iin, the same compression is performed in both of relatively dark and bright portions of the image data. On the other hand, in one example of functions 620 and 630, a compression rate is reduced in a relatively dark portion of images and the compression rate is raised in a relatively bright portion thereof. When the data compression is performed, an image volume can be reduced in the defect candidate extraction unit 130. Further, a memory capacity to be needed can be reduced and the image transfer efficiency can be improved.

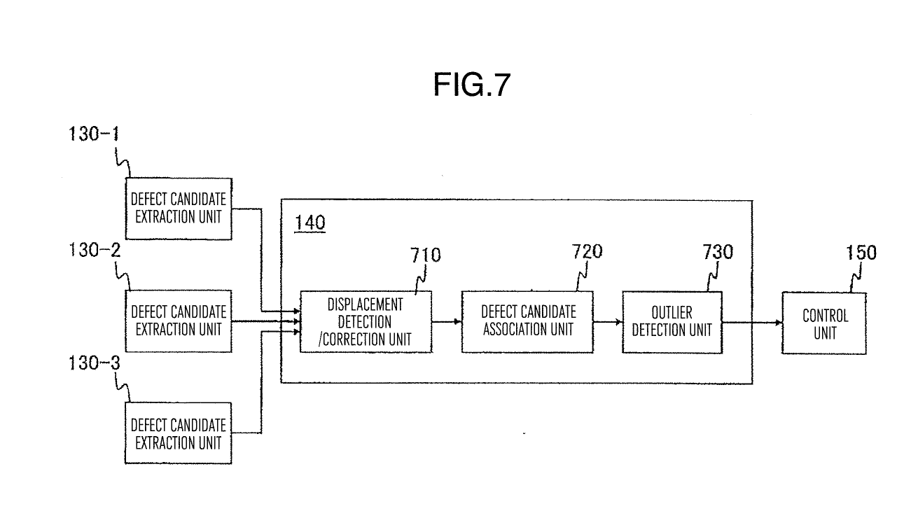

FIG. 7 illustrates one example of the configuration of the defect candidate selection unit 140 in the first embodiment of the defect inspection device according to the present invention. The defect candidate selection unit 140 includes a displacement detection/correction unit 710, a defect candidate association unit 720, and an outlier detection unit 730. The displacement detection/correction unit 710 receives images and feature amounts of a plurality of defect candidates and detection positions on wafers from each of the defect candidate extraction units 130-1, 130-2, and 130-3, and detects displacement of wafer coordinates in each defect candidate for correction.

By associating a defect candidate in which a detection position is corrected by the displacement detection/correction unit 710, the defect candidate association unit 720 determines whether the defect candidate detected by each defect determination unit is a defect candidate (hereinafter, referred to as a single defect) detected by a single defect determination unit or a defect candidate (hereinafter, referred to as a common defect) in which the same defect is detected by a plurality of defect determination units. The defect candidate association unit 720 performs association by using a method for determining whether defect candidates are overlapped in the range previously set on wafer coordinates.

The outlier detection unit 730 sets a threshold to the defect candidate associated by the defect candidate association unit 720, detects a defect candidate in a position deviated in the feature space, and supplies a feature amount and a detection position of the defect candidate to the control unit 150. At this time, for the common defect, a feature amount produced from each defect determination unit may be integrated by a linear or nonlinear function and an outlier may be determined. Suppose that as one example of the feature amount integration, feature amounts produced from each defect determination unit are set as x1, x2, and x3, and further arbitrarily set weights are set as w1, w2, and w3. In this case, a linear integration function is set as g=w1x1+w2x2+w3 and a nonlinear integration function is set as g=x1x2×3. Further, when the integration function g is greater than or equal to the set threshold, it is determined as an outlier. To the single defect and the common defect, respectively, different thresholds can be further set. A high threshold can be set to the single defect and a low threshold can be set to the common defect. An upper limit may be further set to the number of defect candidates supplied to the control unit 150. In the case of exceeding the upper limit, a defect candidate may be supplied to the control unit 150 in the order corresponding to a defect in which likelihood from the threshold is large.

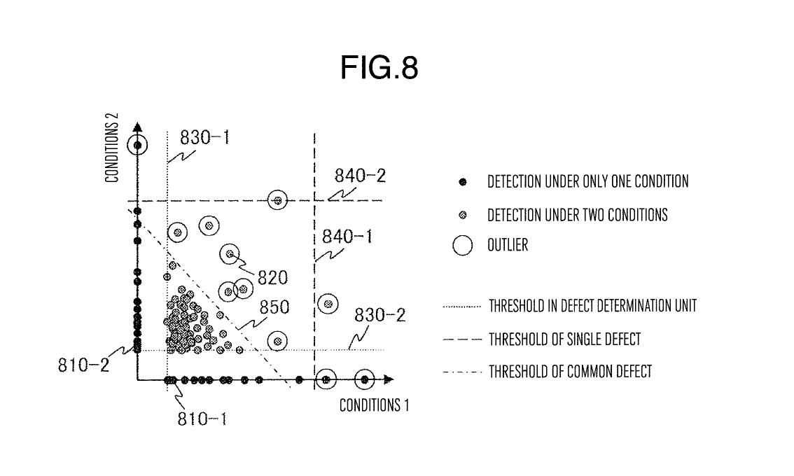

FIG. 8 illustrates one example of the feature space treated by the defect candidate selection unit 140 and a threshold determined by the outlier detection unit 730. FIG. 8 illustrates an example of the two-dimensional feature space based on the feature amounts of the defect candidates produced from the two defect candidate extraction units 130-1 and 130-2 (acquisition conditions 1 and 2). Among the defect candidates which are greater than or equal to a threshold 830-1 in the defect candidate extraction unit 130-1, a single defect 810-1 detected only by the defect candidate extraction unit 130-1 is determined as an outlier based on a threshold 840-1. Among the defect candidates which are greater than or equal to a threshold 830-2 in the defect candidate extraction unit 130-2, a single defect 810-2 detected only by the defect candidate extraction unit 130-2 is determined as an outlier based on a threshold 840-2. A common defect 820 detected by the defect candidate extraction units 130-1 and 130-2 is determined as an outlier based on a threshold 850. The defect candidates which are greater than or equal to each threshold are set as outliers (the defect candidates encircled in the drawing).

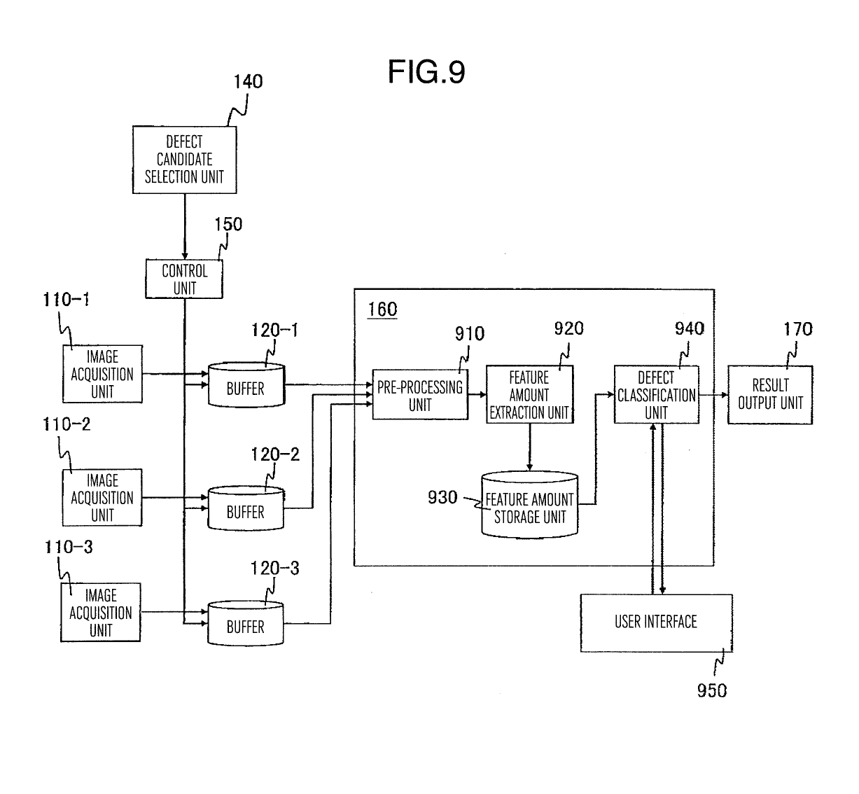

FIG. 9 illustrates one example of configurations of the image storage buffers and the integration post-processing unit 160 in the first embodiment of the defect inspection device according to the present invention. The control unit 150 receives a detection position of the defect candidate determined as an outlier by the defect candidate selection unit 140 and sets an image cutout position. In the defect cutout, the detection image in a region to be inspected including a defect candidate and the reference image to be compared are cut out to each defect candidate. At this time, also in the defect candidates determined as a single defect by the defect candidate selection unit 140, the same image cutout position is set to all the image storage buffers 120-1, 120-2, and 120-3. From the image storage buffers 120-1, 120-2, and 120-3, the integration post-processing unit 160 receives partial image data of the image cutout position determined by the control unit 150. The integration post-processing unit 160 includes a pre-processing unit 910, an image storage unit 920, a defect classification unit 940, and a user interface 950. With respect to the supplied partial image data and the partial image data of each image storage buffer 120, the pre-processing unit 910 performs an image alignment in units of sub-pixel and an adjustment of the brightness shift of the images between respective image data sets. From the pre-processing unit 910, the feature amount extraction unit 920 receives partial image data of the detection image and the reference image under each image acquisition condition, and calculates the feature amount of the defect candidate. The feature amount to be calculated is (1) brightness, (2) contrast, (3) a contrast difference, (4) a brightness dispersion value of adjacent pixels, (5) a correlation coefficient, (6) increase and decrease in brightness of adjacent pixels, and (7) a secondary differential value of each defect candidate. The feature amount extraction unit 920 stores feature amounts in the feature amount storage unit 930 until the number of defect candidates becomes a fixed value or the defect candidates of a constant area in a wafer are extracted by the defect candidate extraction unit 130. The defect classification unit 940 receives feature amounts of a fixed number of defect candidates stored in the feature amount storage unit 930, creates a feature space, and performs a classification based on the distribution of the defect candidates in the feature space. The defect classification unit 940 performs a classification of the supplied defect candidates to an important defect (DOI) and an unimportant defect (Nuisance), a classification of in-film defect and on-film defect, a classification of defect kinds to foreign matters and scratches, and a separation of disinformation through real defects and noises. Here, the defect classification unit 940 is connected to the user interface 950, and can input teaching from the user. Via the user interface, the user can teach a DOI that the user wants to detect. The result output unit 170 outputs results classified by the defect classification unit 940.

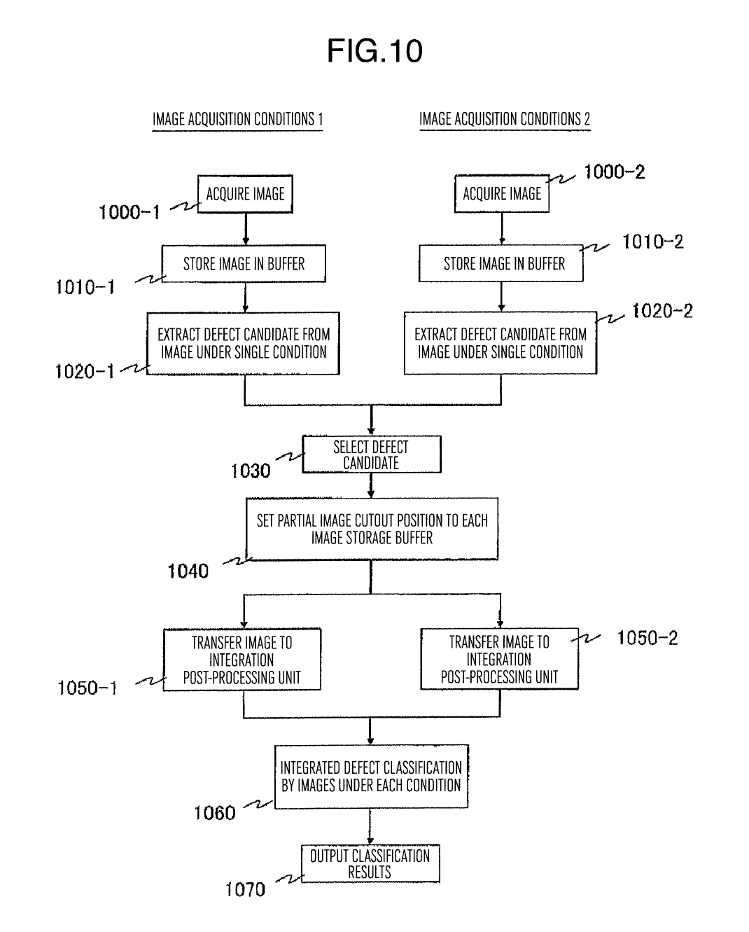

FIG. 10 illustrates one example of the process flow of defect inspection in the first embodiment of the defect inspection device according to the present invention, and here illustrates a process flow in the case where two image acquisition conditions are used. Images are acquired under each image acquisition condition (1000-1 and 1000-2), and stored in the image storage buffers 120-1 and 120-2 (1010-1 and 1010-2). A defect candidate is extracted from images acquired under each condition (1020-1 and 1020-2). The defect candidate selection unit 140 selects defect candidates through the association of the defect candidates under each image acquisition condition and the outlier calculation (1030). Then, the defect candidate selection unit 140 sets a partial image cutout position to each image storage buffer 120 (1040), and transfers partial image data to the integration post-processing unit 160 from each image storage buffer 120 (1050-1 and 1050-2). The integration post-processing unit integrates images under each condition and performs a defect classification (1060). The integration post-processing unit supplies classification results (1070).

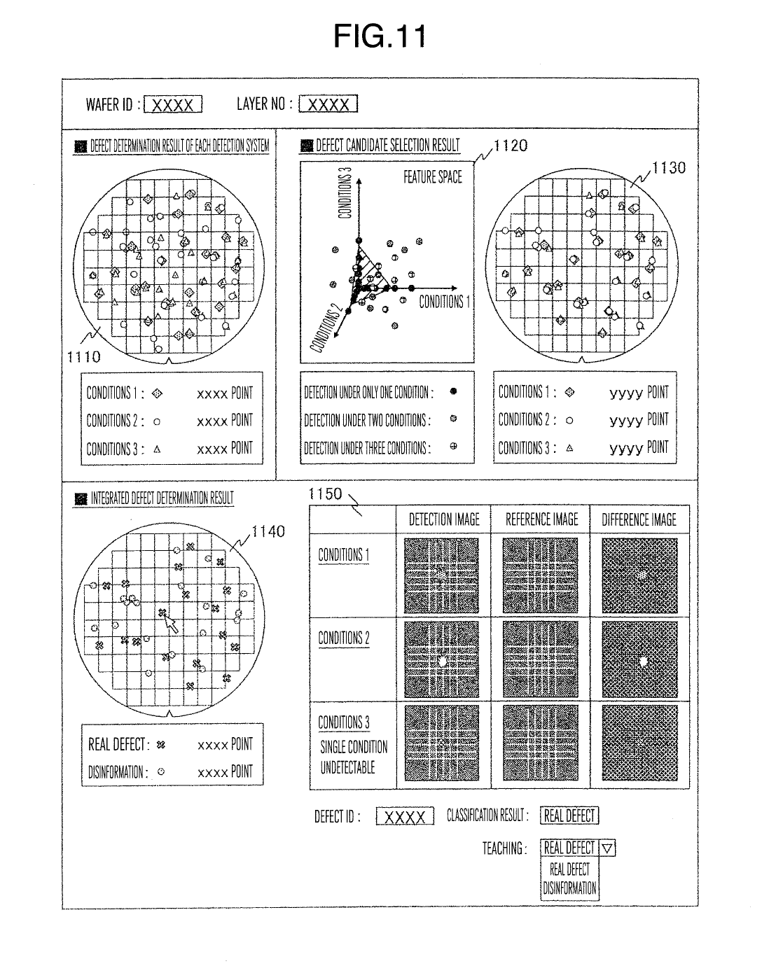

FIG. 11 illustrates one example of a graphic user interface in the first embodiment of the defect inspection device according to the present invention. By using the defect candidate extraction unit 130, the user confirms a wafer map 1110 indicating results performed by the defect candidate extraction unit 130 based on images under each image acquisition condition. By using the defect candidate selection unit 140, the user confirms a feature space 1120 for determining an outlier of the defect candidate and a wafer map 1130 indicating the defect candidate which is supplied to the integration post-processing unit 160 as a result of a selection of the defect candidates. By using the integration post-processing unit 160, the user confirms a wafer map 1140 indicating results in the case of classifying real defects and disinformation, and a defect candidate image 1150 under each image acquisition condition. Further, the user can input a teaching.

### Second Embodiment

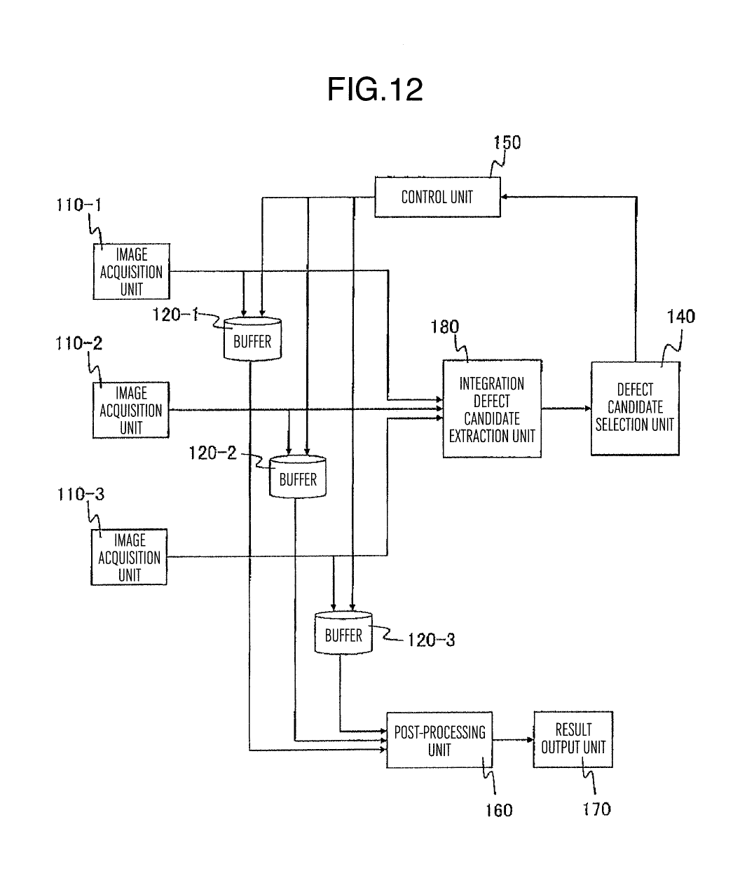

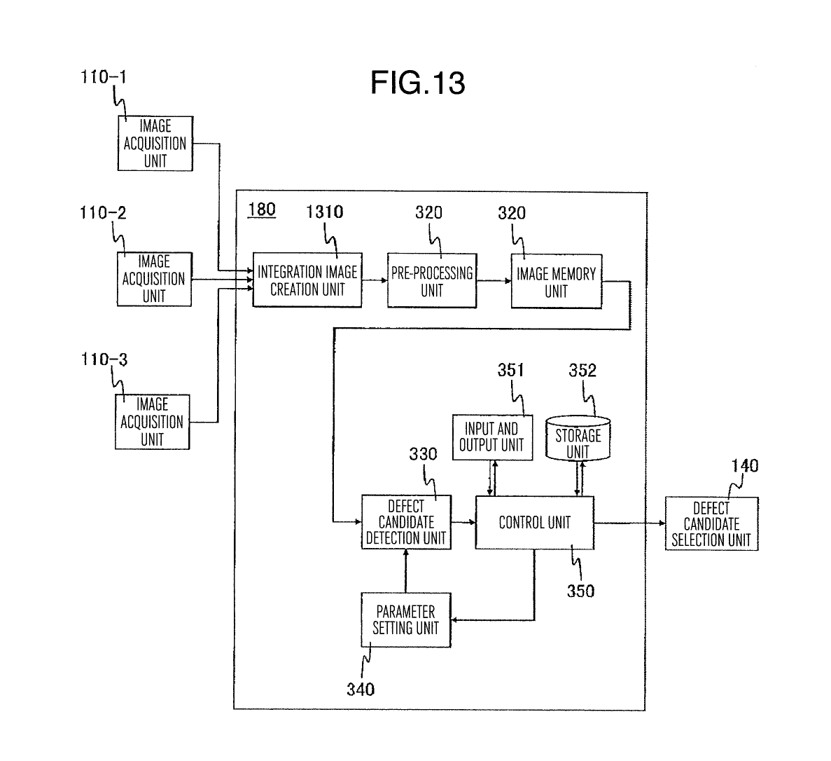

Hereinafter, a second embodiment of the defect inspection technique (the defect inspection method and the defect inspection device) of the present invention will be described with reference to FIGS. 12 and 13.

In the defect inspection technique described in the first embodiment, there will be described an embodiment in which image data acquired by the image acquisition units 110-1, 110-2, and 110-3 under a plurality of image acquisition conditions is supplied to an integration defect candidate extraction unit 180.

FIG. 12 illustrates one example of the configuration of the defect inspection device of the second embodiment. The defect inspection device according to the second embodiment includes the image acquisition units 110, the image storage buffers 120, the integration defect candidate extraction unit 180, the defect candidate selection unit 140, the control unit 150, the integration post-processing unit 160, and the result output unit 170. Similarly to the first embodiment, the image acquisition units 110 acquire image data under a plurality of image acquisition conditions. The integration defect candidate extraction unit 180 integrates image data produced from the image acquisition units 110-1, 110-2, and 110-3 and extracts defect candidates.

The defect candidate selection unit 140 eliminates, from the defect candidates, disinformation being a false detection such as noises or Nuisance that a user does not want to detect, and transmits information about the left defect candidates to the control unit 150. From the control unit 150 to the image storage buffers 120, coordinates of the left defect candidates are transmitted. From the image data stored in the image storage buffers 120, an image including defect candidates is cut out and the defect candidate image is transferred to the integration post-processing unit 160. The integration post-processing unit 160 extracts as the defect candidate image only a DOI (Defect of Interest) being a defect that the user wants to detect through a process to be hereinafter described, and supplies the DOI to the result output unit 170.

FIG. 13 illustrates one example of the configuration of the integration defect candidate extraction unit 180 of the second embodiment. An integration image creation unit 1310 detects and corrects displacement of each image data produced from the image acquisition units 110-1, 110-2, and 110-3 to create an integration image. In the integration image, a linear sum in which a weighted sum of both respective image data sets is calculated may be calculated and a nonlinear integration may be performed. The integration image creation unit 1310 supplies a created integration image to the pre-processing unit. Processes of the pre-processing unit 320 or later are set to be the same as that of the first embodiment.

In the second embodiment, there is described an example where integration is performed by using a format in which an integration image is created from each image data. Further, there may be performed a method for extracting a feature amount from each image, creating a feature space based on the feature amount of a corresponding pixel, and extracting an outlier in the feature space as a defect candidate.

### Third Embodiment

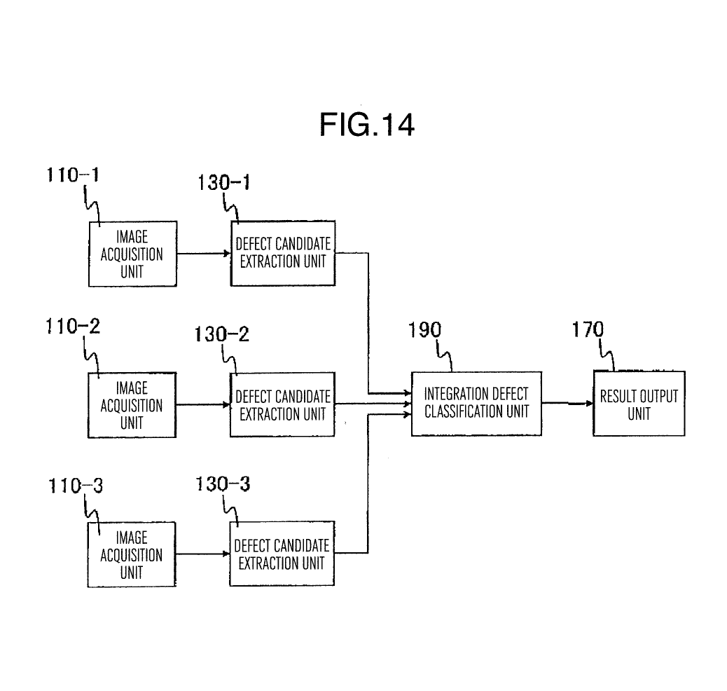

Hereinafter, a third embodiment of the defect inspection technique (the defect inspection method and the defect inspection device) of the present invention will be described with reference to FIGS. 14 to 16.

In the defect inspection technique described in the first embodiment, there will be described an embodiment in which image data sets are acquired by the image acquisition units 110-1, 110-2, and 110-3 under a plurality of image acquisition conditions, defect candidates are extracted from each image data, and the extracted defect candidates are supplied to the integration defect classification unit 180.

FIG. 14 illustrates one example of the configuration of the defect inspection device of the third embodiment. The defect inspection device according to the third embodiment includes the image acquisition units 110, the defect candidate extraction units 130, an integration defect classification unit 190, and the result output unit 170. Similarly to the first embodiment, the image acquisition units 110-1, 110-2, and 110-3 acquire image data sets under a plurality of image acquisition conditions. Similarly to the first embodiment, the defect candidate extraction units 130-1, 130-2, and 130-3 extract defect candidates from the respective image data sets acquired by the image acquisition units 110-1, 110-2, and 110-3.

The integration defect classification unit 190 receives the defect candidates acquired by the defect candidate extraction units 130-1, 130-2, and 130-3, and detects and corrects displacement of each defect candidate. Further, the integration defect classification unit 190 performs a defect classification, and supplies classification results to the result output unit 170.

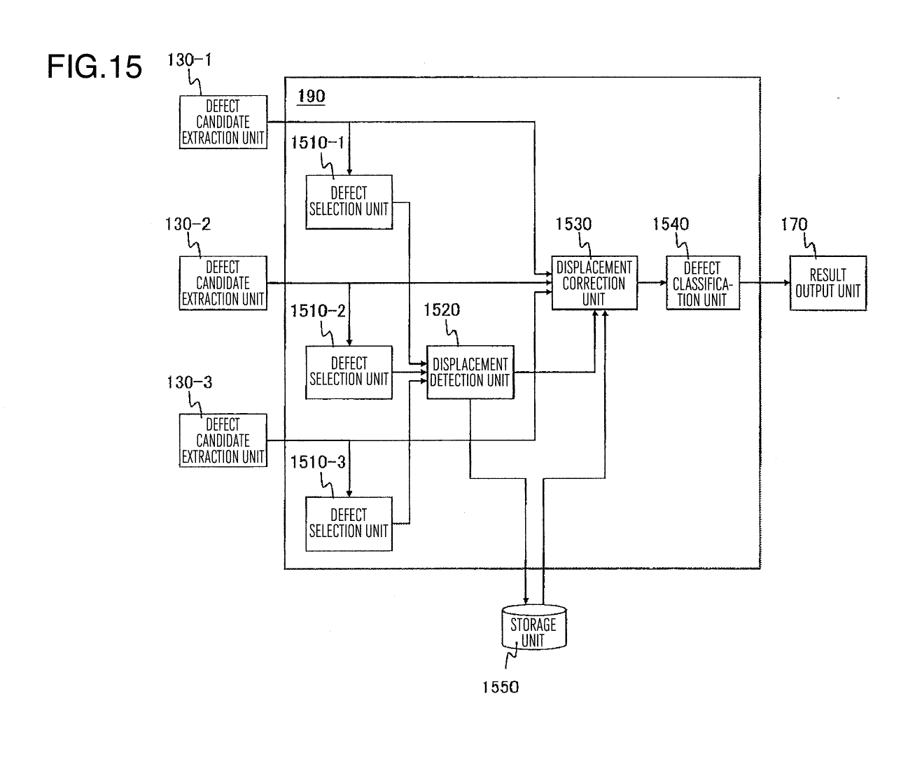

FIG. 15 illustrates one example of the configuration of the integration defect classification unit 190 of the third embodiment. The integration defect classification unit 190 includes defect selection units 1510, a displacement detection unit 1520, a displacement correction unit 1530, and a defect classification unit 1540.

The defect selection units 1510-1, 1510-2, and 1510-3 select defect candidates for use in an alignment from the defect candidates produced from the defect candidate extraction units 130-1, 130-2, and 130-3. A reference for selecting the defect candidate includes a brightness difference between the detection image and the reference image, a size and a shape of a defect, and a combination thereof.

The displacement detection unit 1520 calculates a displacement amount of the defect candidate based on the defect candidates selected by the defect selection units 1510. Examples of the method for calculating the displacement amount include:

(1) temporary association of both the closest points of each defect candidate,

(2) calculation of such a displacement amount that the distance between both the temporarily associated defect candidates is minimized,

(3) correction of the displacement, and

(4) repetition of the above (1) to (3) until the displacement amount is converged.

Based on the displacement amount produced from the displacement detection unit 1520, the displacement correction unit 1530 performs a displacement correction to the defect candidates produced from the defect candidate extraction units 130-1, 130-2, and 130-3.

The defect classification unit 1540 extracts a feature amount from the defect candidates corrected by the displacement correction unit 1530, and classifies the defect candidates. The defect candidates are classified by using the same method as that of the first embodiment. The defect classification unit 1540 supplies the obtained classification results of the defect candidates to the result output unit 170.

Further, the displacement amount calculated by the displacement detection unit 1520 is stored in the storage unit 1550, and the displacement correction unit 1530 reads in the displacement amount stored in the storage unit 1550 to thereby perform the displacement correction.

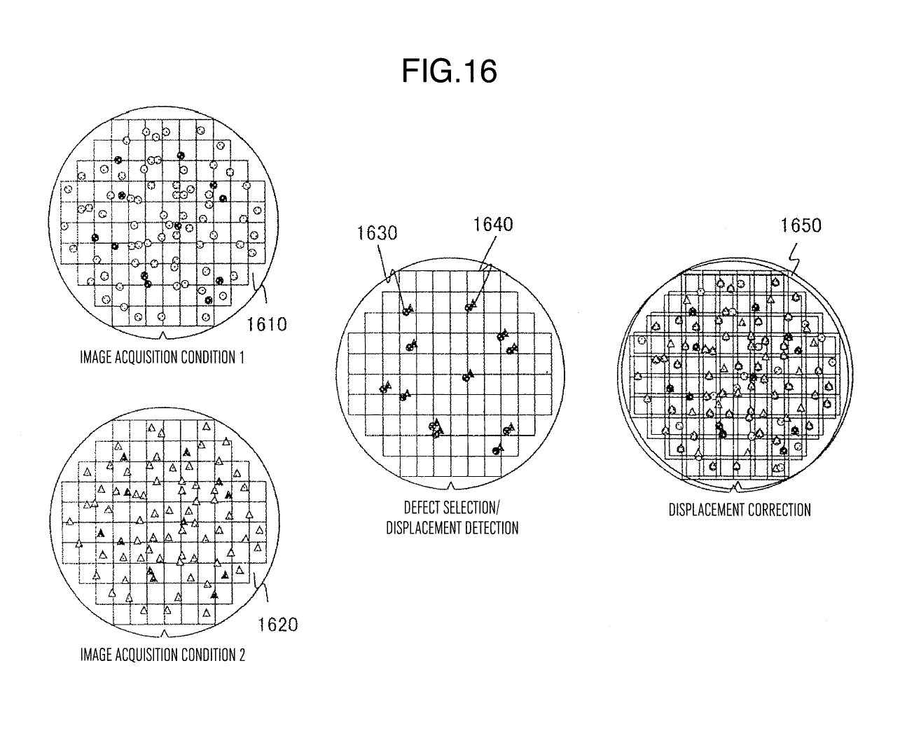

FIG. 16 illustrates one example of the displacement correction of the defect candidates in the integration defect classification unit 190. Defect candidates 1630 and 1640 for use in displacement detection are selected from defect candidates 1610 and 1620 under the image acquisition conditions 1 and 2, respectively, and a displacement amount is calculated based on the selected defect candidates. The displacement of the defect candidates 1610 and 1620 under the image acquisition conditions 1 and 2 is corrected based on the calculated displacement amount (1650).

In the first to third embodiments, an example where the dark-field type inspection device is used as an inspection device is described. Further, the first to third embodiments are applicable to inspection devices of all systems such as the bright-field type inspection device and an SEM type inspection device. According to the inspection devices of a plurality of systems, images can be acquired under a plurality of image acquisition conditions and defects can be determined.

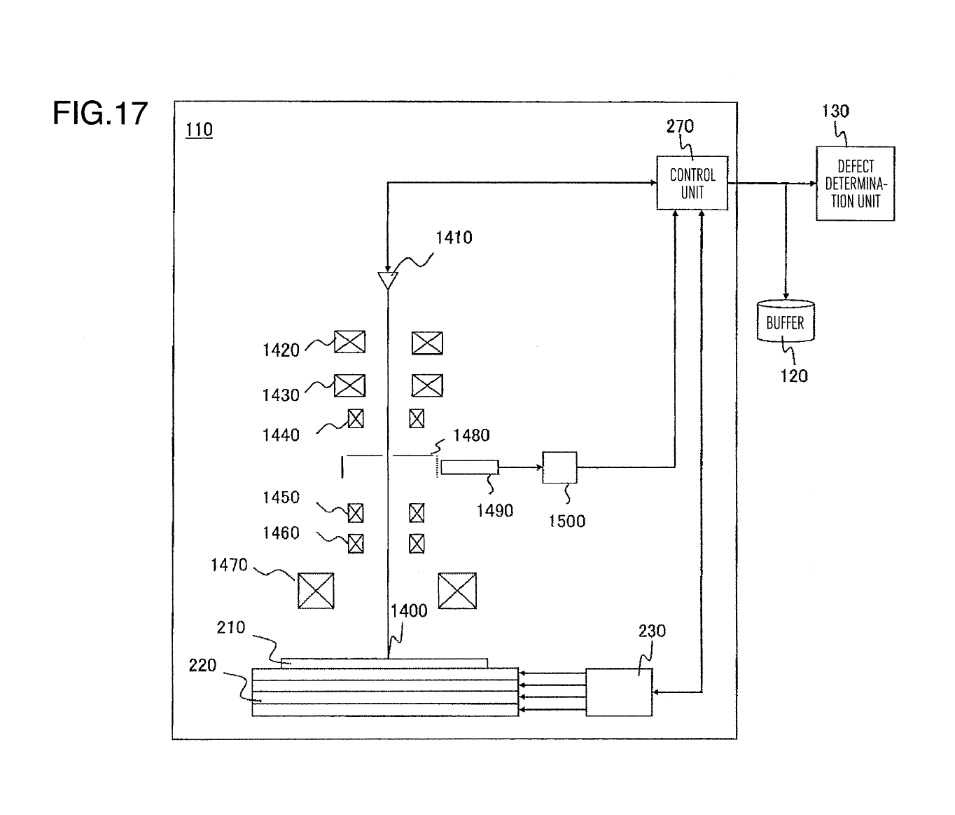

FIG. 17 illustrates one example of the configuration of the SEM type inspection device. The same portions as those of the dark-field type inspection device described in the first embodiment or portions which perform the same operations as those of the dark-field type inspection device are indicated by the same reference numerals. After electron beams irradiated from an electron beam source 1410 pass through condenser lenses 1420 and 1430, astigmatism or alignment deviation is corrected through an electron beam-axis adjuster 1440. Scanning units 1450 and 1460 slant electron beams and control a position on which the electron beams are irradiated. The electron beams are converged by objective lenses 1470 and irradiated on an object to be imaged 1400 of the wafer 210. As a result, secondary electrons and reflection electrons are emitted from the object to be imaged 1400. The secondary electrons and the reflection electrons collide against a reflecting plate having a primary electron beam passing hole 1410 and secondary electrons generated thereon are detected by an electron detector 1490. The secondary electrons and the reflection electrons detected by the primary electron beam passing hole 1410 are converted to digital signals by an A/D converter 1500, and transferred to the control unit 270.

### REFERENCE SIGNS LIST

110 Image acquisition unit
120 Image storage buffer
130 Defect candidate extraction unit
140 Defect candidate selection unit
150 Control unit
160 Integration post-processing unit
170 Result output unit
210 Wafer
220 Stage
230 Controller
240 Illumination system
250 Detection system
310 Pre-processing unit
320 Image memory unit
330 Defect candidate detection unit
340 Parameter setting unit
350 Control unit
410 Detection image
420 Reference image
430 Alignment unit
440 Feature amount operation unit
450 Feature space formation unit
460 Outlier pixel detection unit
710 Displacement detection/correction unit
720 Defect candidate association unit
730 Outlier detection unit
910 Pre-processing unit
920 Feature amount extraction unit
930 Feature amount storage unit
940 Defect classification unit
950 User interface

1. A defect inspection method comprising the steps of:
acquiring image data sets of a sample under a plurality of imaging conditions;
storing a plurality of image data sets acquired under the plurality of imaging conditions in an image storage unit;
acquiring a defect candidate from each of the plurality of image data sets;
cutting out, from the image data sets acquired under at least two imaging conditions and stored in the image storage unit, partial images each including a position of the defect candidate detected in any of the plurality of image data sets and a periphery of the defect candidate position; and
integrating the partial images acquired under at least two imaging conditions corresponding to the defect candidates, thereby classifying the defect candidates.

2. A defect inspection method comprising the steps of:
acquiring image data sets of a sample under a plurality of imaging conditions;
storing a plurality of image data sets acquired under the plurality of imaging conditions in an image storage unit;
integrating the plurality of image data sets and acquiring a defect candidate;
cutting out, from the image data sets acquired under at least two imaging conditions and stored in the image storage unit, partial images each including a position of the defect candidate and a periphery of the defect candidate position; and
integrating the partial images acquired under at least two imaging conditions corresponding to the defect candidates, thereby classifying the defect candidates.

3. The defect inspection method according to claim 1, wherein the steps of acquiring the defect candidates and classifying the defect candidates are asynchronous.

4. The defect inspection method according to claim 1, wherein an upper limit is set to the number of defect candidates for cutting out the partial image.

5. A defect inspection method comprising the steps of:
acquiring image data sets of a sample under a plurality of imaging conditions;
detecting a defect candidate from each of the plurality of image data sets;
selecting a defect candidate for calculating a displacement amount of the defect candidate;
calculating a displacement amount of the defect candidate acquired from the plurality of image data sets based on a displacement amount of the selected defect candidate; and
calculating a correspondence relationship between the respective defect candidates based on the displacement amount, thereby classifying the defect candidates.

6. A defect inspection device comprising:
a detection optical system which acquires image data sets of a sample under a plurality of imaging conditions;
an image storage unit which stores a plurality of image data sets acquired under the plurality of imaging conditions;
a defect candidate detection unit which detects a defect candidate from each of the plurality of image data sets;
an image cutting out unit which cuts out, from the image data sets acquired under at least two imaging conditions and stored in the image storage unit, a partial images each including a position of the defect candidate detected in any of the plurality of image data sets and a periphery of the defect candidate position; and
an integration post-processing unit which integrates the partial images acquired under at least two imaging conditions corresponding to the defect candidates to thereby classify the defect candidates.

7. A defect inspection device comprising:
a detection optical system which acquires image data sets of a sample under a plurality of imaging conditions;
an image storage unit which stores a plurality of image data sets acquired under the plurality of imaging conditions;
a defect candidate detection unit which integrates the plurality of image data sets and acquires a defect candidate;
an image cutting out unit which cuts out, from the image data sets acquired under at least two imaging conditions and stored in the image storage unit, a partial images each including a position of the defect candidate and a periphery of the defect candidate position; and
an integration post-processing unit which integrates the partial images acquired under at least two imaging conditions corresponding to the defect candidates to thereby classify the defect candidates.

8. The defect inspection device according to claim 6, wherein the defect candidate detection unit and the integration post-processing unit are asynchronous.

9. The defect inspection device according to claim 6, wherein an upper limit is set to the number of defect candidates for cutting out the partial image.

10. A defect inspection device comprising:
a detection optical system which acquires image data sets of a sample under a plurality of imaging conditions;
a defect candidate detection unit which detects a defect candidate from each of the plurality of image data sets;
a defect candidate selection unit which selects a defect candidate for calculating a displacement amount of the defect candidate;
a displacement amount calculation unit which calculates a displacement amount of the defect candidate acquired from the plurality of image data sets based on a displacement amount of the selected defect candidate; and
an integration processing unit which calculates a correspondence relationship between the respective defect candidates based on the displacement amount to thereby classify the defect candidates.

11. The defect inspection method according to claim 2, wherein the steps of acquiring the defect candidates and classifying the defect candidates are asynchronous.

12. The defect inspection method according to claim 2, wherein an upper limit is set to the number of defect candidates for cutting out the partial image.

13. The defect inspection method according to claim 11, wherein an upper limit is set to the number of defect candidates for cutting out the partial image.

14. The defect inspection device according to claim 7, wherein the defect candidate detection unit and the integration post-processing unit are asynchronous.

15. The defect inspection device according to claim 7, wherein an upper limit is set to the number of defect candidates for cutting out the partial image.

16. The defect inspection device according to claim 14, wherein an upper limit is set to the number of defect candidates for cutting out the partial image.
